(19) United States
(12) Patent Application Publication
(10) Pub. No.: US 2015/0042186 A1
(43) Pub. Date: Feb. 12, 2015

(54) ELECTRICAL SYSTEM AND METHOD FOR SUSTAINING AN EXTERNAL LOAD

(71) Applicant: Mario A. Galvan, St. Cloud, FL (US)

(72) Inventor: Mario A. Galvan, St. Cloud, FL (US)

(21) Appl. No.: 14/524,583

(22) Filed: Oct. 27, 2014

Related U.S. Application Data
(63) Continuation-in-part of application No. 13/075,414, filed on Mar. 30, 2011, now Pat. No. 8,872,403.
(60) Provisional application No. 61/421,896, filed on Dec. 10, 2010.

(51) Int. Cl. H02K 47/04; H02K 9/19; H02K 16/00

(52) U.S. Cl. CPC H02K 47/04; H02K 16/00; H02K 9/19; Y10S 74/09; H02K 53/00
USPC 310/54; 310/114; 310/113; 74/DIG. 9

(57) ABSTRACT

An electrical power system is disclosed having at least a first magnetic power generator and at least a second magnetic power generator wherein a first part of the first magnetic power generator is positioned within the at least second magnetic power generator and a second part of the first magnetic power generator is positioned outside of the second magnetic power generator. Other systems and a method are also disclosed.

### CROSS-REFERENCE TO RELATED APPLICATIONS

This application is a Continuation-in-Part of U.S. application Ser. No. 13/075,414 filed Mar. 30, 2011, which claims the benefit of U.S. Provisional Application No. 61/421,896 filed Dec. 10, 2010, and incorporated herein by reference in its entirety.

### BACKGROUND

Exemplary embodiments of the invention relate generally to a power supply and, more specifically, to a system and method for sustaining an external load with minimum external power.

With the continued rise in cost of fuel or energy sources, a need for more affordable fuel or energy sources is desired. Some more affordable fuel sources, such as solar power and wind power, have several built-in limitations. For example, both solar power and wind power require physical space for solar arrays or wind turbines. Thus, an individual residing in a home, condominium, or apartment may be limited on an ability to use such power sources. Another emerging power source is nuclear. However, nuclear power is not a technology that is readily available to an individual as only electric companies have an ability to satisfy government regulations to produce a nuclear power plant. Further, individuals would not require a power plant, but just a simple unit that could be used individually.

Thus, in view of the limitations recognized with other power sources, individuals would benefit from having an ability to provide sustainable power to a load while minimizing an amount of external power needed to sustain the load.

### SUMMARY

Embodiment are directed to a system and method, specifically an electrical system that may be used for sustaining an external load, and a method. The system is an electrical power system comprising at least a first magnetic power generator and at least a second magnetic power generator. A first part of the first magnetic power generator is positioned within the at least second magnetic power generator and a second part of the first magnetic power generator is positioned outside of the second magnetic power generator.

Another system is an electrical power system comprising at least a first core comprising a first magnet rotor and a first stator and at least a second core comprising a second magnet rotor and a second stator with a first part of the first core positioned within the second core and a second part of the first core positioned outside the second core. The first part of the first core produces a first magnetic field, the second part of the first core produces a second magnetic field, and the second core produces a third magnetic field. The first magnetic field, the second magnetic field, and the third magnetic field combine to function as a single magnetic field.

The method comprises operating a first core, comprising a first rotor and a first stator, with a first part of the first rotor and first stator located within a second core, comprising a second rotor and a second stator, and a second part of the first rotor and the first stator located outside of the second core. The method also comprises creating a first magnetic field with the first part of the first core, creating a second magnetic field with the second part of the first core, creating a third magnetic field with the second core, and combining the first magnetic field, second magnetic field, and third magnetic field to create a combined magnetic field.

Another system is an electrical power system comprising at least a first core, comprising a first magnet rotor and a first stator, and at least a second core, comprising a second magnet rotor and a second stator, with a first part of the first core positioned within the second core and a second part of the first core positioned outside the second core, wherein the first core produces a first magnetic field that is determined by having the first part of the first core positioned within the second core and the second part of the first core positioned outside the second core and the second core produces a second magnetic field, and wherein the first magnetic field and the second magnetic field combine to function as a third magnetic field.

### BRIEF DESCRIPTION OF THE DRAWINGS

FIG. 1 discloses a block diagram of a self-generating electrical power system capable of sustaining a load;

FIG. 2 discloses a diagram of an inside view of the generator depicting a dual core generator;

FIG. 3 discloses a side view of a front end of another exemplary embodiment of the dual core generator;

FIG. 4 discloses a cross sectional side view of another embodiment of the dual core generator;

FIG. 5 discloses a top view of an internal configuration of the generator;

FIG. 6 discloses a front view of gears operating the generator in combination with gears from transmission gear system;

FIGS. 7A-7B show varied simplified embodiments of FIG. 4;

FIG. 8 shows an embodiment of a multi-core generator;

FIG. 9 discloses a block diagram of a self-generating electrical power system in a contained unit;

FIG. 10 discloses another block diagram of a self-generating electrical power system capable of sustaining a load;

FIG. 11 discloses diagram of a self-generating electrical power system capable of sustaining a load;

FIG. 12 discloses a diagram of the generating electrical power system used in an electric power plant and/or a desalination water plant;

FIG. 13 discloses an embodiment of a cross sectional side view of a cooling system for the electrical power system;

FIG. 14 discloses another embodiment of a cross sectional side view of a cooling system for the electrical power system;

FIG. 15 discloses a flowchart illustrating an exemplary method for sustaining an electrical load with a sustainable electrical system; and

FIG. 16 discloses another flowchart illustrating a method.

### DETAILED DESCRIPTION

Reference will now be made in detail to the embodiments consistent with the invention, examples of which are illustrated in the accompanying drawings. Wherever possible, the same reference numerals used throughout the drawings refer to the same or like parts. The scope of the invention disclosed is applicable to a plurality of uses, a few of which are disclosed below.

It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid Obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

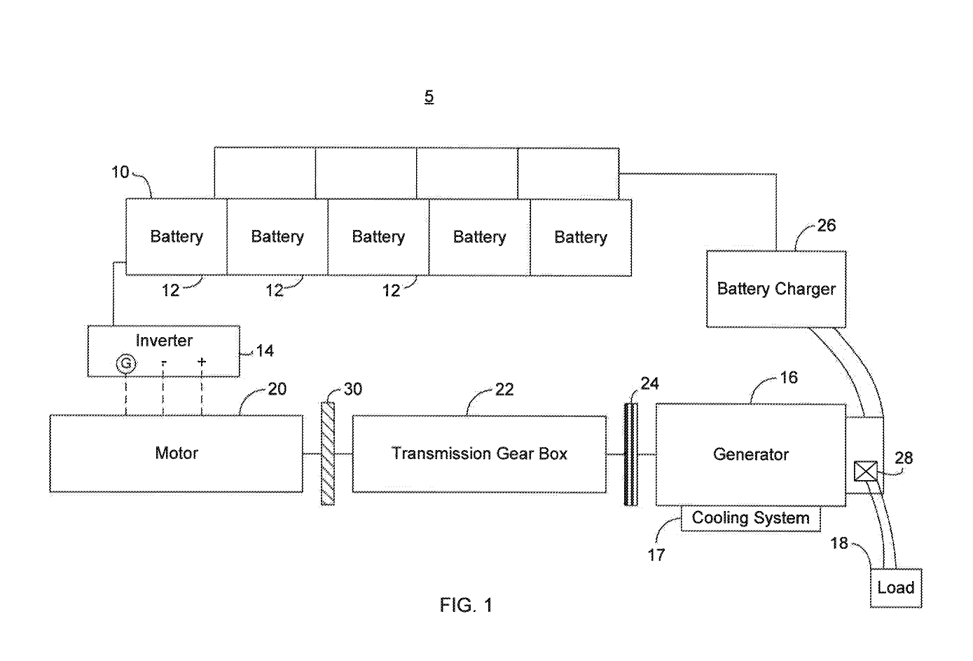

FIG. 1 discloses a block diagram of a self generating electrical power system 5 capable of sustaining a load. As illustrated, a bank 10 of rechargeable batteries 12 is provided, though depending on the battery technology and the function of the system 5, only one battery 12 may be used. The type of battery 12 is not limiting. For example, the battery may be lithium ion cells or a twelve (12) volt battery 12. The batteries 12 provide power to an inverter 14. The batteries 12 are primarily used to start the system 5, more specifically, the generator 16, and also to provide additional power, such as a boost, if additional power is needed for peak performance by the system 5 or a load 18 connected to the system 5. A cooling system 17 for cooling the generator 16 may be provided. The inverter 14 converts power from the batteries 12 for use by a motor 20, such as an electric motor. The motor 20 turns a torque conversion system 22. For example, the torque conversion system 22, or torque transmission system, may comprise a transmission gear box and/or chain drive which turns an inertia, torque, wheel, or weight 24. The torque conversion system 22 then operates the generator 16. The gear ratio for the torque conversion system 22 is determined by the revolutions per minute produced by the motor 20. Thus, the ratio is not necessarily a constant ratio. The generator 16 provides electrical power to a battery charger 26 to recharge the batteries 12, and includes an outlet 28 to provide electricity to the load 18, typically an external load. A motor cooling system 30 is also provided to cool the motor 20, namely, as to maintain the motor 20 at an acceptable operating temperature.

In more detail, an exemplary illustration of the system 5 may include 12 volt batteries wired to the inverter 14. The inverter 14 provides power to a 120 volt electric motor 20 Where the motor 20 operates at 1,740 revolutions per minute (RPM). The motor 20 turns a transmission gear box 22, or chain drive, at a 2.069 ratio which turns a torque Wheel 24, Which operates a 240 volt generator 16 at 3600 RPM. Power is provided to a 12 volt battery charger 26 and at least one outlet 28 is provided for use by the external load 18. The battery charger electrical output is determined by the battery amperage and the size of the motor 20.

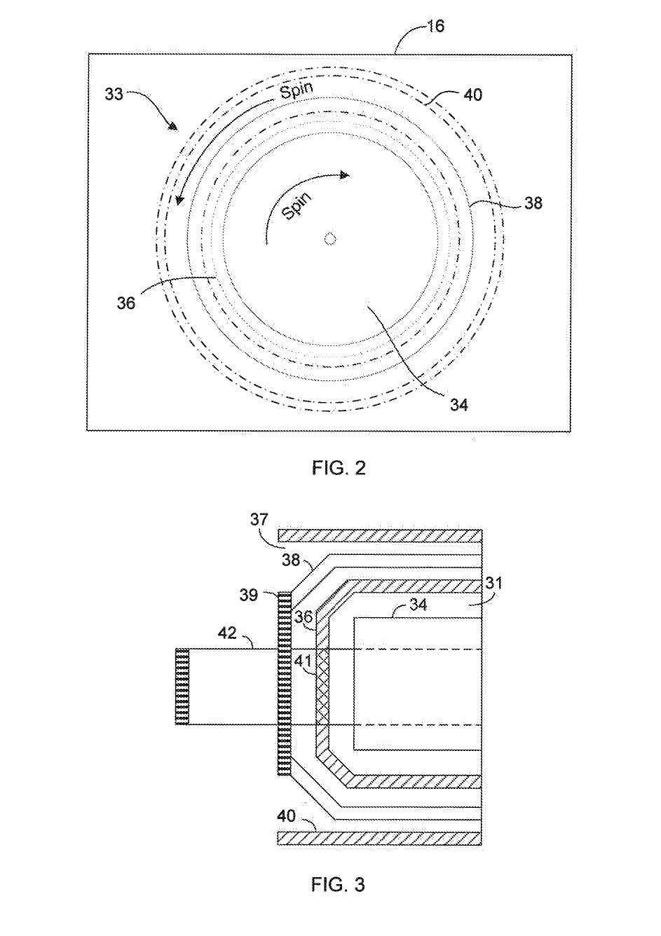

FIG. 2 discloses a diagram illustrating a front inside view of the generator depicting a dual core generator. Though described as a generator, the same embodiment may be applicable to an electric motor. Therefore, the term “generator” is not used to be limiting. As explained herein, though the term “dual core” is used not meant to be limiting as more than two cores may be used. At a minimum, an embodiment may comprise a configuration with a multi core generator wherein a first core is at least partially located within a second core and a third core. The generator 16 or electric motor may comprise a dual core generator 33. In another embodiment, the generator 16 and dual core generator 33 are a same element, meaning these terms may be used interchangeably. As illustrated, a first core 31 may be located within a second core 37. More specifically, a first magnet rotor 34 may be provided that spins in a first direction, such as clockwise. A first multi-winding stator 36 may surround at least a part the inner magnet rotor 34. The first magnet rotor 34 and the first multi-winding stator 36 may be parts of the first core 31. A second magnet rotor 38 may surround the first multi-winding stator 36, and may spin in an opposite direction of the first magnet rotor 34, in this example, counter-clockwise. A second multi-winding stator 40 may surround the second magnet rotor 38. The second magnet rotor 38 and the second multi-winding stator 40 may comprise the second core 37. Though the above suggests that at least one core has a part that may be rotating, in another embodiment, one of the cores may not have a part which is rotating.

FIG. 3 discloses a side view of a front end of another exemplary embodiment of the dual core generator. The first magnet rotor 34 may be on a main shaft 42, and may ride on, or rotate based on, free spinning bearings 41. The second magnet rotor 38 may ride on bearings with a gear/sprocket 39. The gear/sprocket 39 may be located on the front or back of the dual core generator 33. When the shaft 42 spins in one direction the rear gear/sprocket may be configured to turn the second magnet rotor 38 in an opposite direction, such as with use of a chain drive (not shown). When this spin is created, the first magnet rotor 34 riding on the bearings 41 is held in place by the opposite spin of the second magnet rotor 38.

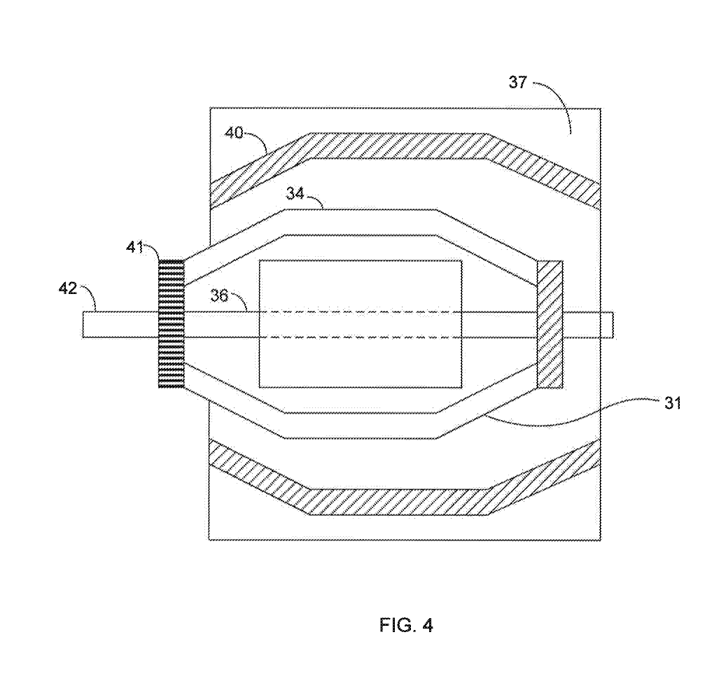

FIG. 4 discloses a side view of another embodiment of the dual core generator. As illustrated, a signal magnet 34 is located in between the first multi-winding stator 36 and the second multi-winding stator 40. The magnet 34 may be connected to the shaft 42 with bearings 41. The magnet 34 may rotate in between the two stators 36, 40.

In another embodiment, the first magnet rotor 34 may be configured to spin whereas the second magnet rotor 38 is configured to remain stationary. In yet other embodiment, either the first multi-winding stator 36 is configured to spin while the second multi-winding stator 40 remains stationary or the first multi-winding stator 36 remains stationary when the second multi-winding stator 40 spins. Additionally, in another embodiment, when a free riding stator is utilized, the bearings 41 may be or include a clutch mechanism, so that when clutch mechanism is configured to hold the stator stationary if operation of the generator requires it to remain stationary.

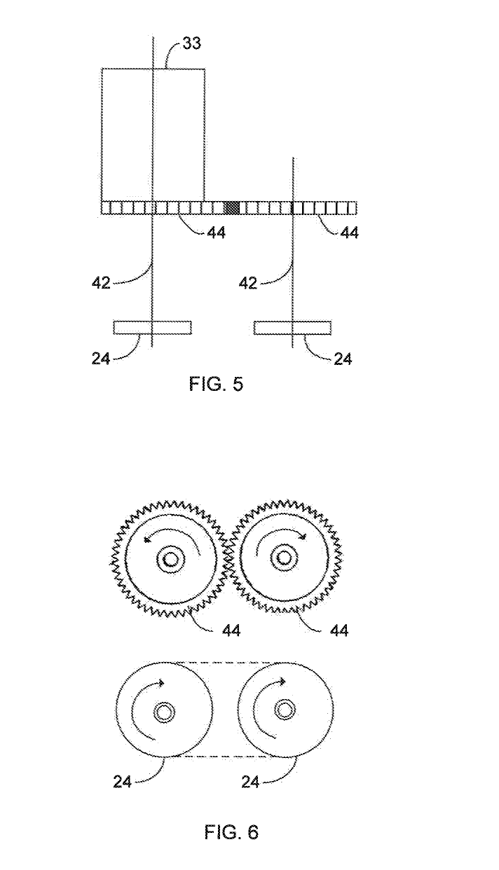

FIG. 5 discloses a top view of an exemplary embodiment of the generator 16, and FIG. 6 discloses a front view of gears operating the generator in combination with gears from transmission gear system 22. The gears 24 from the transmission gear system 22 are connected via a first shaft 42 and a second shaft 43 to a set of gears 44 in communication with the dual core generator 33. The set of gears 44 rotate in an opposite direction from each other and each respective gear 44 control the rotation a respective one of the magnet rotors 34, 38, as explained above, wherein the gear operating opposite the gears 24 is able to operate opposite because of a bearing/gear/sprocket arrangement.

In another exemplary embodiment, the first core is not surrounded by the second core of the dual core generator, but both cores are still configured with the each respective magnet rotor 34, 38 operating in an opposite direction from the other magnet rotor 34, 38. In another exemplary embodiment, the magnet rotors 34, 38 operate or spin in the same direction. However, spinning in opposite directions will result in more power being generated than when the magnet rotors 34 38 spin in the same direction.

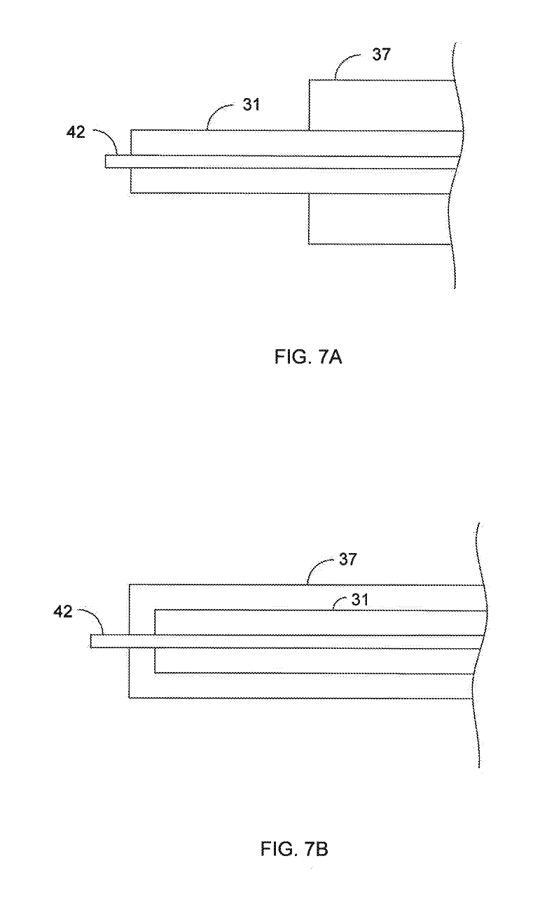

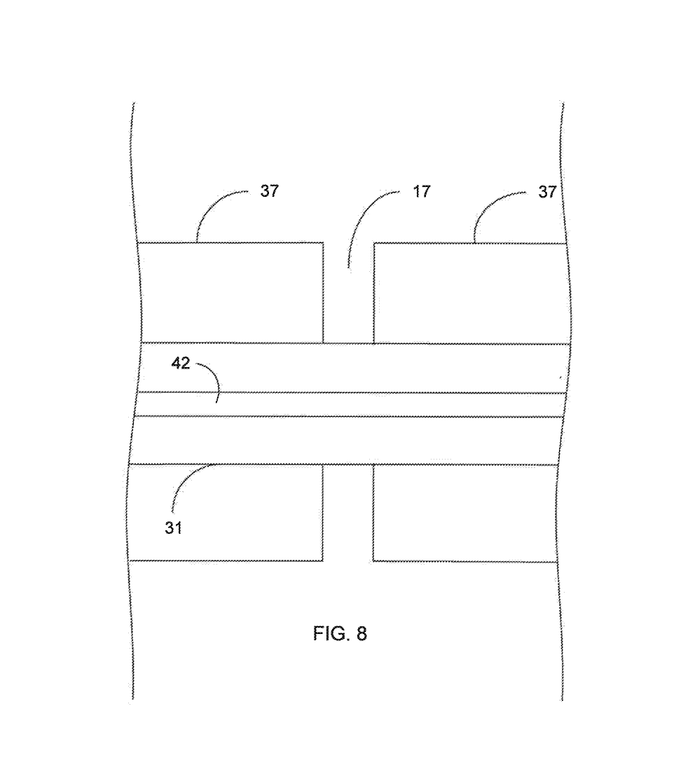

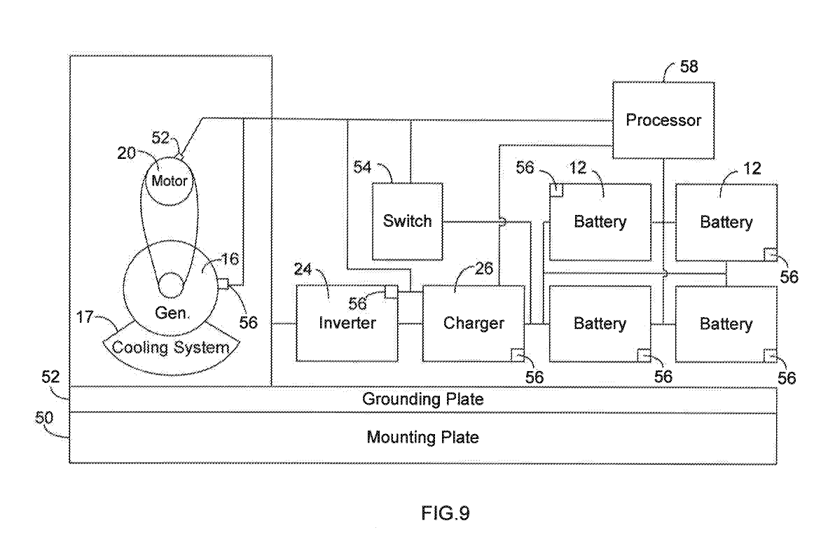

FIGS. 7A-7B show varied simplified cross sectional embodiments of FIG. 4. As illustrated in FIG. 7A, at least one end of the inner core 31 may extend from the same end of the outer core 37. Though not illustrated, both ends of the inner core 31 may extend from the respective ends of the outer core 37. As illustrated in FIG. 7B, the inner core 31 and outer core 37 may be configured Where at least one end of outer core 37 extends beyond the end of the inner core 31. Though both ends of the inner core are within the outer core as illustrated in FIG. 7B, in another embodiment, only one end of the inner core may be located within the outer core 37. Also illustrated is the shaft 42 which may rotate parts of both the outer core 37 and the inner core 31, as disclosed herein.

A physical relationship between the inner core and the outer core may be varied, based on an intended use. In a non-limiting embodiment, a surface area of the inner core may be approximately the same as amount of surface area as the surface area of the outer core. In another non-limiting example, an amount of the inner core may be positioned within the outer core wherein at least one end of the outer core may extend beyond an end of the inner core. The amount of the inner core that extends out of the outer core may be approximately fifty percent a length of the inner core. In other non-limiting examples, it may be more than or less than fifty percent. An operating frequency of each core may be used to determine how far the inner core extends out of the outer core.

Magnetically, in a perspective, the outer core 37 generates a first magnetic field. A part of the inner core 31 that is within the outer core 37 generates a second magnetic field. The part of the inner core 31 that is outside of the outer core 37 generates a third magnetic field. Thus, with a part of the inner core 31 being located within the outer core 37, the magnetic field of the outer core 37 may cause the inner core 31 to produce two magnetic fields. The two magnetic fields produced by the inner core 31 may also exist even when either the outer core or the inner core is not rotating. During operation, the magnetic fields generated by the inner core 31 are combined with the magnetic field of the outer core 37 to create a combined magnetic field. This combined, or zero gravity magnetic field results in the individual magnetic fields from canceling each other out, collapsing, or exploding.

From another perspective the outer core 37 generates the first magnetic field wherein the inner core 37 creates a second magnetic field, which is biased or altered due to a part of the inner core 31 being located inside the outer core 37 and another part of the inner core 31 is located outside of the outer core 37. These two magnetic fields then create a third magnetic field, which may be recognized as a zero gravity field which means it shields both magnetic fields from canceling out, collapsing, or exploding.

Though not limiting, the combining of the magnetic fields may be envisioned as the fields combining by swirling together to form a combined magnetic field. With respect to the first perspective, just as the three magnetic fields are created when at least one end of the inner core extends beyond the outer core, three magnetic fields are created when at least one end of the outer core extends beyond the respective end of the inner core. In such a configuration, the outer core produces the two magnetic fields whereas the inner core produces one magnetic field. In operation, the three fields combine and stabilize instantaneously once the system is initiated. A similar occurrence takes place when considering the magnetic fields from the second perspective.

By producing the multiple magnetic fields with the inner core extending out of the outer core, the generator may operate at high frequencies, over approximately 1300 hertz +/1 1000 hertz up to at least approximately 10,000 hertz. Operating at such higher frequencies may provide for cleaner higher frequencies which may result in power being communicated without a need of wire as another physical transporter or bridge between the generator/electric motor and an intended receiver.

The cores 31, 37 may operate in either a same phase or different phases. Furthermore, the cores may operate in series or in parallel. As such, the cores may operate at the same rotational speed or different rotational fees. Similarly, each core may produce a same amount of power or different amounts of power. These variables may be possible as depended on a frequency or strength of the magnetic fields of each individual core. The cores may also operate at different frequencies. As a non-limiting example, the outer core 37 may operated at 60 hertz whereas the inner core 31 may operate at 40 hertz.

Thus, varied magnetic fields per core 31, 37 are possible where different magnetic fields may exist per core. Depending on the application, an efficiency of the system may be established. As a non-limiting example, when fifty percent (50%) of the inner core extends from one end of the outer core, an efficiency of ninety-eight percent (98%) may be realized with the system.

By having one core operating within another core, redundancy is realized. As a non-limiting example, fifty percent (50%) redundancy may be realized. Thus, should one core cease to function properly, the other core may provide redundancy in place of the core that is not functioning properly. In another embodiment, by having the two cores operating together, more power may be produced. The generator/electric motor may be stackable with at least one other generator/electric motor where neither is limited to a same rotation of speed, operating frequency, poles, and/or phases. As a non-limiting example of being stackable, with reference to FIG. 7A, the end of the inner core 31 distant from the outer core 37 may he mated with an end of another inner core 31 which is distant from its outer core 37. The shafts 42 of both generators/electric motors 16 may interconnect through a coupling (not shown), as a non-limiting example, wherein only a single drive may be used to turn both shafts. Such a configuration may be considered as providing for a quad core generator/electric motor. Additionally, when compared to a prior art generation system or electric motor, a weight reduction is realized with the embodiments disclosed herein when a same amount of power is to be produced by either generator. The weight reduction may be in excess of approximately thirty percent (30%).

The at least two cores 31, 37 may be at least one of a generator and/or an electric motor. Thus, one core may be a part of a first generator and the other core may be a part of a second generator, one core may be a part of a first electric motor and the other core may be a part of the second electric motor, or one core may be part of a generator and the other core may be part of an electric motor. As discussed above, the one core or the other core may be either the inner core or the outer core.

FIG. 8 shows an embodiment of a multi-core generator. As illustrated, at least three cores are used. Two outer cores 37 are provided and one inner core 31 that is located within both outer cores 37, A space 47 may be provided between the first outer core and the second outer core to separate magnetic fields generated by each outer core. A distance of the space 47 may he determinative by the magnetic fields produced. As a non-limiting example, the space 47 may be as small as a centimeter, but again this distance is determinative by the magnetic fields generated. Though three cores are illustrated, more than three cores may be used. As a non-limiting example the inner core 31 may extend beyond one of the outer cores and yet another outer core may then enclose a part of the inner core. Furthermore, as explained above, the cores may be any combination of electric motors and generators.

In a non-limiting example, by having a multi-core configuration as illustrated, approximately one third the torque needed to turn the cores may be used while producing one third more power, when compared with a dual core generator disclosed above. Thus, where a dual core generator may operate at 147 lbs-torque and produce approximately 20 kilowatts (Kw) of power, a multi-core generator disclosed in FIG. 8 may operate at ⅓ less torque and produce approximately 30 Kw of power. Both versions may still operate at a same revolution per minute, approximately 900 RMP.

FIG. 9 discloses a block diagram of a generating electrical power system in a contained unit. As illustrated, all components discussed above are situated on a mounting plate 50, where the plate 50 also includes a grounding plate 52 to ground all elements. In other words, the grounding plate 52 is provided as a grounding source since the system is in a contained unit which is transportable, or movable from one location to another. Being within a contained unit, the system 5 may be moved about freely by a user to any location where the user prefers to use the system 5. Also disclosed is a switch 54, or switching device. When a plurality of batteries is used, not all batteries are necessarily required at all times. The switch 54 in conjunction with sensors 56 may be used to determine which battery 12 is used and automate switching between batteries 12 is possible to distribute the degradation of the batteries 12 across all batteries 12 more uniformly, such as by switching between which batteries are being discharged and/or discharged. The system 5 may be integrated to a processor 58 wherein a status of each battery 12 is determined based on the sensors 56, such as, but not limited to, voltage sensing sensors. The sensed voltages are provided to the processor 58 which then commands the switch 54 as to which battery 12 to include in the system 5 for producing electricity and which to exclude at a given time. In addition to regulating charging of the batteries, the processor 58 may also control the system 5. For example, if the motor 20 is operating at too high of a temperature, the processor 58 may turn off the system. Thus, sensors 56 may be provided on each element of the system 5, where information from each sensor 56 is provided to the processor 58.

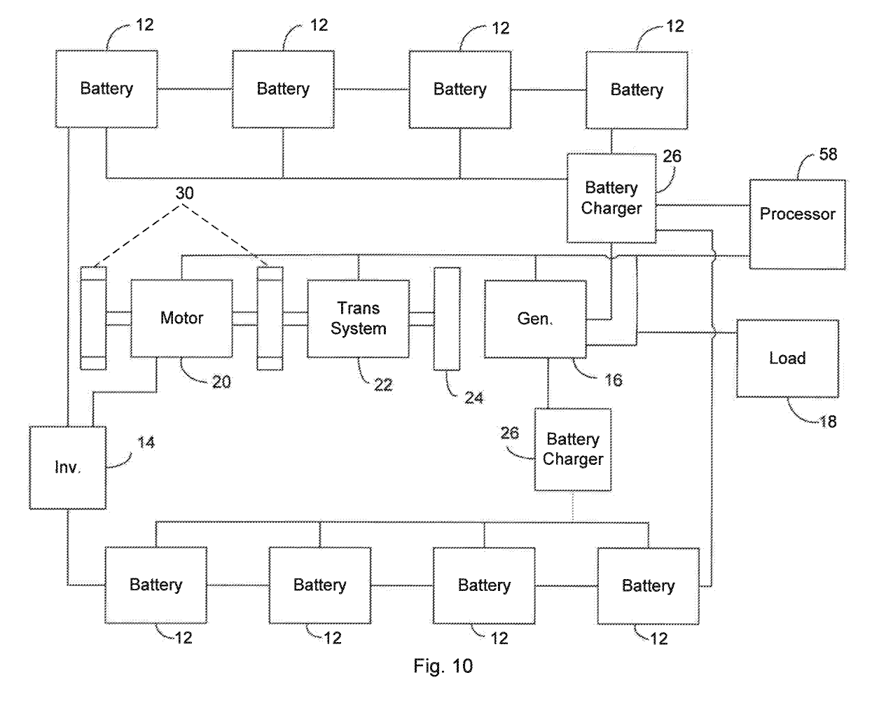

FIG. 10 discloses another block diagram of a generating electrical power system capable of sustaining a load. As illustrated, the motor cooling system 30 may comprise more than one cooling fan. Furthermore, more than one battery charger 26 may be provided. For example, each battery 12 may have its own individual battery charger 26 or a defined number of batteries 12 may utilize certain battery charger 26 when more than one battery 12 is used and more than one battery charger 26 is provided, especially where the batteries 12 outnumber the battery chargers 26.

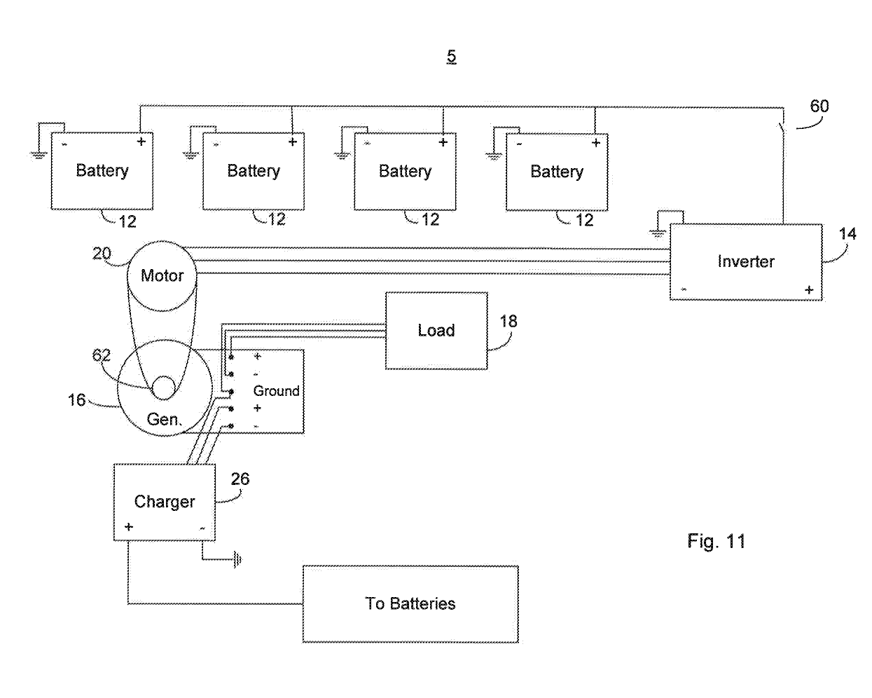

FIG. 11 discloses a diagram of an electrical power system capable of sustaining a load. As illustrated, a switch device 60 is further illustrated for switching on and off When a battery 12 is within the system 5. Also illustrated is the generator 16 having an inertia weight 62. The motor 20 may drive a sheave to belt driven inertia weight. In an exemplary embodiment, the generator 16 may produce 120 volts on two legs, equaling 240 volts.

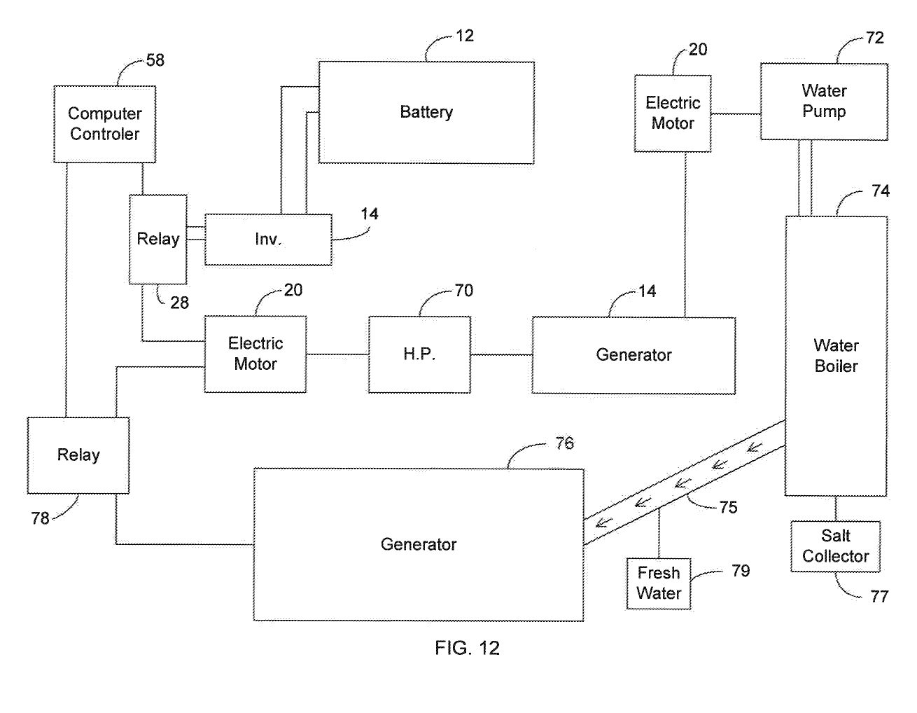

FIG. 12 discloses a diagram of the generating electrical power system disclosed above used in an electric power plant and/or a desalination water plant. As illustrated, battery pack 10 provides power, via the inverter 14, to the electric motor 20. The motor spins a hydraulic pump 70, which in turn spins the generator 16 to create electricity that powers an electric, water pump 72, via another electric motor 20. The water pump is connected to a water boiler 74 that produces steam 75 which power a steam generator 76. The steam generator provides power to the first electric motor 20, which results in a creation of sustainable clean energy. Also illustrated is a processor 58 or computer controller. Also illustrated are relays 78 or switching devices controllable by the processor 58. The relay is configured to shut down the system when the operational condition of the rechargeable battery 12, charger 26, electric motor 20, and/or generator 16 is at an unacceptable condition. Also illustrated is a receiver 77 which collects the salt boiled off of the water When salt water is used. A container 79 to collect the desalinated water is also provided. The location of both the receiver 77 and container 79 are not limiting as they may be located a plurality of places to capture the intended by-products.

Though batteries are disclosed, they may be replaced with solar panels, wind turbines, and/or a conventional combustion engine generator to start to process of providing electricity to the system 5. Depending on the intended use of the system 5, the various components may be configured to power the main electric motor 20 for different environments, or configured based on specifications of the various elements.

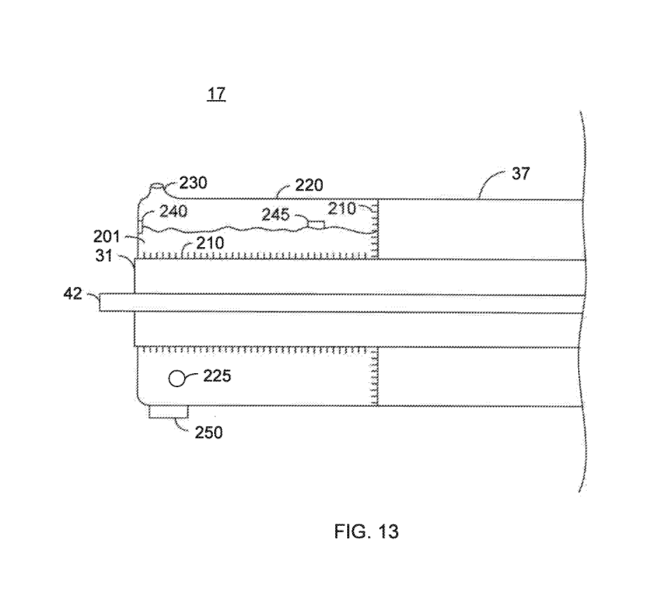

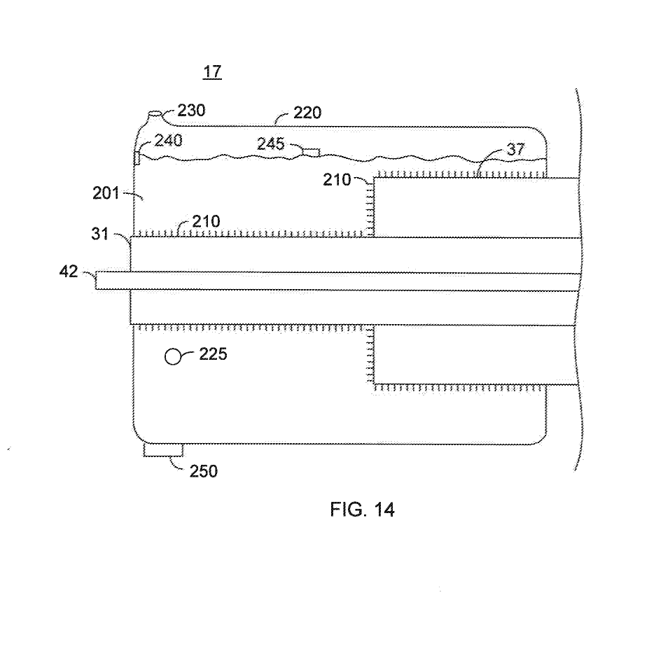

FIG. 13 shows a cross sectional view of a generator/electric motor cooling system which may be used with a generator or electric motor. As illustrated in FIG. 1, the cooling system 17 may in communication with the generator 16 or electric motor. The cooling system 17 may improve operations of the generator/electric motor. A fan-based cooling system may be used. In another non-limiting embodiment, as further illustrated in FIGS. 13 and 14, a coolant based system may be used where a coolant 201 is in direct contact with at least one of the cores 31, 37. As illustrated the cores 31, 37 are configured to be sealed on an outer surface so that coolant 201 may not pass into either generator/electric motor or core. At least one coolant fin 210 may extend from an outer surface of both or at least one of the cores 31, 37. A tank, pool, or basin 220 may be provided which either surrounds at least one of the cores 31, 37 or into which at least one of the cores 31, 37 may be partially or completely submerged. Therefore, though only the inner core 31 is shown as being completely submerged in FIG, 13, and the outer core 37 having parts of the outer surface in contact with the tank 220, this configuration is not provided to be limiting. In other embodiments, the outer core 37 may be completely submerged with only a section of the inner core 31 submerged or both cores 31, 37 may be completely submerged. FIG. 14 illustrates another non-limiting embodiment Where more of the outer core 37 is also within the tank 220. Furthermore, the tank 220 may be configured to only provide for one core being partially or completely submerged.

The tank 220 may comprises at least one inlet 225 and at least one outlet 230. Depending on the configuration and use, the at least one inlet 225 and the at least one outlet 230 may have particular functions. As a non-limiting example, the inlet 225 may be used to provide additional coolant 201 within the tank 220. The coolant 201 may be any material that may take a liquid form. As a non-limiting example, the coolant 201 may be water where the water may be any type of water, including seawater. In another non-limiting embodiment, the coolant 201 may have a solid form capable of transforming to a liquid form and/or gas form. The outlet 230 may be configured so that the coolant 201 exits through the outlet primarily in a gaseous form (wherein the form may still be part liquid or completely liquid), such as, but not limited to, primarily as steam. In another non-limiting example, the coolant 201 may be continuously passed through the tank and out of the tank Where cooler coolant is fed through the inlet 225 and warmer/heated coolant 201 is then released through the outlet 230, where the heated coolant 201. may not have changed physical state. As a non-limiting example, another at least one outlet 230 may be provided to provide for a byproduct of the coolant, such as, but not limited to, salt when saltwater is used as the coolant, to be collected. Thus, as disclosed herein the function of the inlet 225 and the outlet 230 are not meant to be limiting as each are representative of a means to provide a component into the tank 220 and a means to remove a component form the tank 220.

A sensor 240 may be provided to ensure that a level of the coolant remains at a given level. More specifically, coolant flow may be monitored to ensure an amount needed to cover at least one of the cores is identified. In another embodiment a floater type sensor 245 may be used to identify when a level of coolant reaches a certain level, in which additional coolant is then added. As illustrated, the coolant may be provided to cover all of the inner core 31 extending from the outer core 37 where the tank also is configured so that coolant is in communication with a part of the outer core 31. Since the coolant 201 will leave the tank 220 When in gaseous form, a controller 250 may be provided to initiate introducing additional coolant through the inlet 225 when at least one of the sensors 240, 245 determines that not enough coolant is within the tank 220.

As disclosed with respect to FIG. 12, when used as part of a desalination plant, another tank or receiver 77 may be provided to collect the salt whereas the steam, in which the salt has been removed from through the heating process may be delivered from the outlet 230 to a collector or the container 79 so that the steam converts back to a liquid state where salt, or at least a certain amount of salt has been removed. Using such a cooling system as disclosed, power output may be improved up to ten times as additional torque may be applied to product higher power outputs. True water cooling may also be realized. Furthermore, desalination capacities may be realized where purer de-salted water may be realized. As illustrated with F 12, steam output may drive a steam turbine resulting in more cleaner energy.

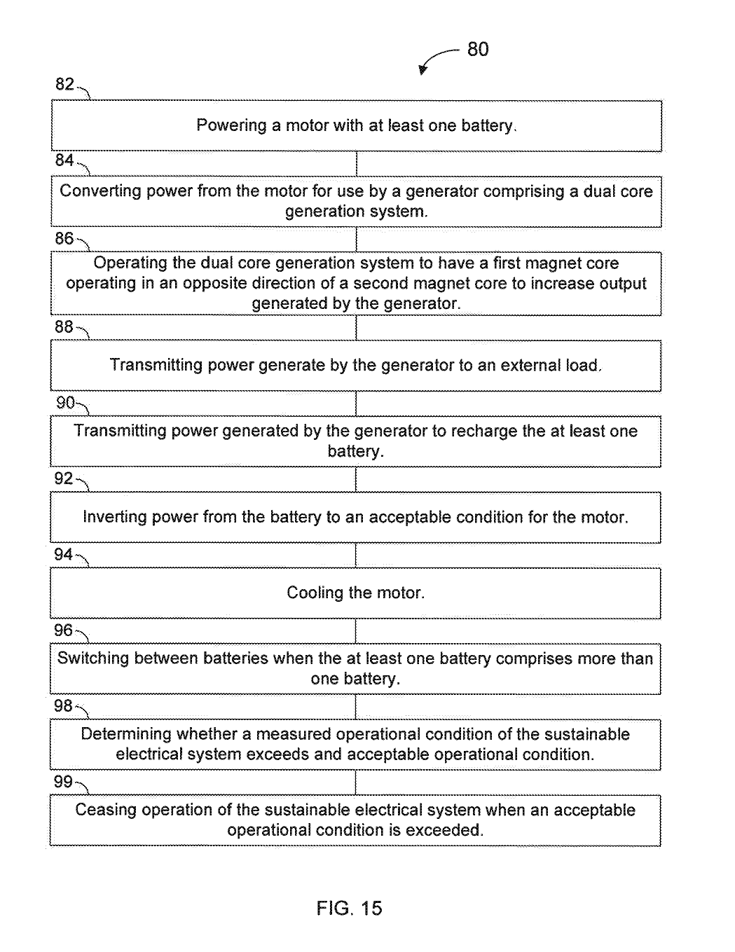

FIG. 15 discloses a flowchart illustrating an exemplary method for sustaining an electrical load with a sustainable electrical system. The method 80 comprises powering a motor with at least one battery, at 82, converting power from the motor for use by a generator comprising a dual core generation system, at 84, operating the dual core generation system to have a. first magnet core operating in an opposite direction of a. second magnet core to increase output generated by the generator, at 86, transmitting power generated by the generator to an external load, at 88, and transmitting power generated by the generator to recharge the at least one battery, at 90. The method 80 further comprises inverting power from the battery to an acceptable condition for the motor, at 92, cooling the motor, at 94, switching between batteries when the at least one battery comprises more than one battery, at 96, determining whether a measured operational condition of the sustainable electrical system exceeds an acceptable operational condition, at 98, and ceasing operation of the sustainable electrical system when an acceptable operational condition is exceeded, at 99.

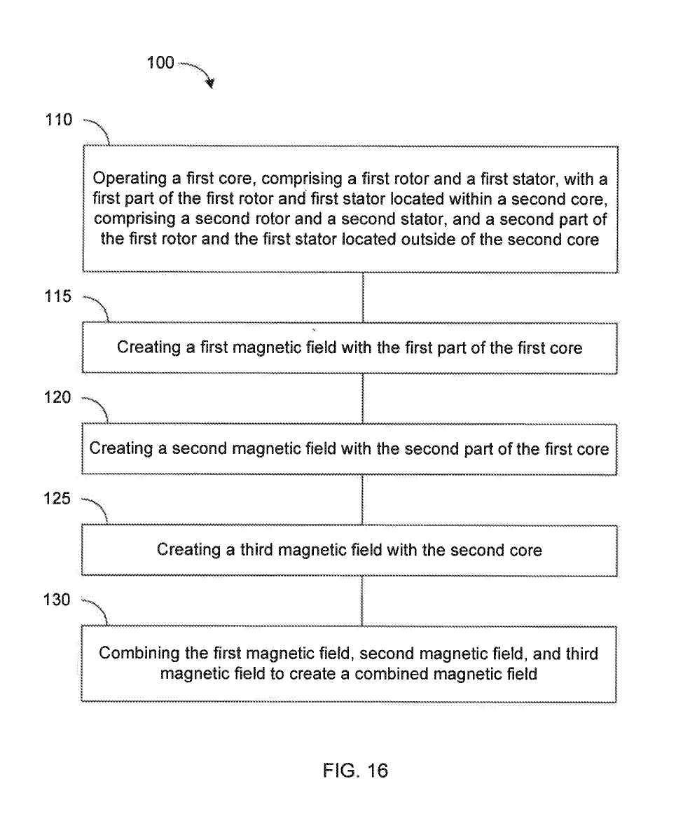

FIG. 16 discloses another flowchart illustrating a method. The method 100 comprises operating a first core, comprising a first rotor and a first stator, with a first part of the first rotor and first stator located within a second core, comprising a second rotor and a second stator, and a second part of the first rotor and the first stator located outside of the second core, at 110. The method further comprises creating a first magnetic field with the first part of the first core, at 115. The method further comprises creating a second magnetic field with the second part of the first core, at 120. The method further comprises creating a third magnetic field with the second core, at 125. The method further comprises combining the first magnetic field, second magnetic field, and third magnetic field to create a combined magnetic field, at 130.

As used in FIG. 16, operating the first core comprises at least one of rotating the first rotor or keeping the first rotor stationary. As disclosed above, either the first core and/or the second core may have a part, namely the core's respective rotor rotating (or in operation). Therefore, the method disclosed in FIG. 16 is not limited to either the first core operating or not operating as each magnetic field is created regardless of whether or not any of the rotors are rotating.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted M an idealized or overly formal sense unless expressly so defined herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

What is claimed is:

1. An electrical power system comprising at least a first magnetic power generator and at least a second magnetic power generator wherein a first part of the first magnetic power generator is positioned within the at least second magnetic power generator and a second part of the first magnetic power generator is positioned outside of the second magnetic power generator.

2. The system as set forth in claim 1, wherein, the at least first magnetic power generator comprises at least a first core further comprising at least a first magnet rotor and at least a first stator and the at least second magnetic generator further comprises at least a second core comprising at least a second magnet rotor and at least a second stator.

3. The system as set forth in claim 2, wherein the at least first magnet rotor is configured to operate in one of an opposite rotational direction and a same rotational direction of the at least second magnet rotor as operation of both the at least first magnet core and at least second magnet core are positioned around a single shaft.

4. The system as set forth in claim 1, wherein the first part of first magnetic power generator produces a first magnetic field, the second part of the first magnetic power generator produces a second magnetic field, and the second magnetic power generator produces a third magnetic field wherein the three fields combine to produce a single magnetic field.

5. The system as set forth in claim 1, wherein the first magnetic power generator produces a first magnetic field that is altered due to a part of the first magnetic power generator being located within the second magnetic power generator, the second magnetic power generator produces a second magnetic field wherein a combination of the first magnetic field and the second magnetic field produce a singular third magnetic field.

6. The system as set forth in claim 4, wherein the first magnetic field and the second magnetic field are different magnetic fields created by placement of the first part of the first magnetic power generator within the second magnetic power generator and the second part of the first magnetic power generator outside the second magnetic power generator.

7. The system as set forth in claim 2, wherein a surface area of the at least first core is approximately equal to a surface area of the at least second core.

8. The system as set forth in claim 2, further comprising a single shaft configured to rotate a part of the at least first magnet core and a part of the at least second magnet core.

9. The system as set forth in claim 8, wherein the part of the first magnet core is the first magnet rotor and the part of the second magnet core is the second magnet rotor.

10. The system as set forth in claim 1, wherein at least one of the at least first magnetic power generator and the at least second magnetic power generator is an electric motor.

12. The system as set forth in claim 2, wherein approximately half of the at least first core is the part of the first magnetic power generator positioned within the at least second magnetic power generator.

13. The system as set forth in claim 1 wherein the first magnetic power generator and the second magnetic power generator operate at least one of a same frequency and different frequencies.

14. The system as set forth in claim 1, further comprising a coolant tank configured to provide a coolant in direct communication with at least a part of an outside surface of the first magnetic power generator or at least a part of an outside surface of the second magnetic power generator, wherein the at least part of the outside surface of the first magnetic power generator or the at least part of the outside surface of the second magnetic power generator is configured to prevent the coolant from passing into the at least one of the first magnetic power generator or the second magnetic power generator.

15. The system as set forth in claim 14, wherein at least one of the part of the first magnetic power generator or the part of the second magnetic power generator is submerged within the coolant.

16. An electrical power system comprising at least a first core, comprising a first magnet rotor and a first stator, and at least a second core, comprising a second magnet rotor and a second stator, with a first part of the first core positioned within the second core and a second part of the first core positioned outside the second core, wherein the first part of the first core produces a first magnetic field, the second part of the first core produces a second magnetic field, and the second core produces a third magnetic field, and wherein the first magnetic field, the second magnetic field, and the third magnetic field combine to function as a single magnetic field.

17. The system as set forth in claim 16, further comprising at least a third core comprising a third magnet rotor and a third stator, wherein a segment of the second part of the at least first core is positioned within the at least third core, and wherein the at least third core is configured to be separated a distance from the at least second core.

18. The system as set forth in claim 17, wherein the distance separating the at least third core from the at least second core is determinative by a magnetic field created by the at least third core and the magnetic field created by the at least second core.

19. The system as set forth in claim 16, further comprising a single shaft configured to rotate a part of the at least first magnet core and a part of the at least second magnet core.

20. The system as set forth in claim 16, further comprising a single shaft wherein the shaft configured to rotate a part of the at least first magnet core, a part of the at least second magnet core, and a part of the at least third magnet core.

21. The system as set forth in claim 16, wherein the part of the first magnet core is the first magnet rotor and the part of the second magnet core is the second magnet rotor.

22. The system as set forth in claim 17, wherein the part of the third magnet core is the third magnet rotor.

23. The system as set forth in claim 17, wherein at least one of the at least first core, the at least second core, and the at least third core is an electric motor.

24. The system as set forth in claim 16, wherein the first magnetic power generator produces a first magnetic field that is altered due to a part of the first magnetic power generator being located within the second magnetic power generator, the second magnetic power generator produces a second magnetic field wherein a combination of the first magnetic field and the second magnetic field produce a singular third magnetic field.

25. A method comprising:
operating a first core, comprising a first rotor and a first stator, with a first part of the first rotor and first stator located within a second core, comprising a second rotor and a second stator, and a second part of the first rotor and the first stator located outside of the second core;
creating a first magnetic field with the first part of the first core;
creating a second magnetic field with the second part of the first core;
creating a third magnetic field with the second core; and
combining the first magnetic field, second magnetic field, and third magnetic field to create a combined magnetic field.

26. The method as set forth in claim 25, wherein operating the first core comprises at least one of rotating the first rotor or keeping the first rotor stationary.

27. An electrical power system comprising at least a first core, comprising a first magnet rotor and a first stator, and at least a second core, comprising a second magnet rotor and a second stator, with a first part of the first core positioned within the second core and a second part of the first core positioned outside the second core, wherein the first core produces a first magnetic field that is determined by having the first part of the first core positioned within the second core and the second part of the first core positioned outside the second core and the second core produces a second magnetic field, and wherein the first magnetic field and the second magnetic field combine to function as a third magnetic field.
